(19) United States
(12) Patent Application Publication
(10) Pub. No.: US 2009/0139809 A1
(43) Pub. Date: Jun. 4, 2009

(54) Plateless Railway Brake Shoe

(75) Inventors: A. Gary Bowden, Laurinburg, NC (US); Timothy A. Rumph, Laurinburg, NC (US)

Correspondence Address: THE WEBB LAW FIRM, P.C., 700 KOPPERS BUILDING, 436 SEVENTH AVENUE, PITTSBURGH, PA, 15219, US

(73) Assignee: RFPC HOLDING CORP., Wilmerding, PA (US)

(21) Appl. No.: 11/947,830

(22) Filed: Nov. 30, 2007

(51) Int. Cl. F16D 69/00

(52) U.S. Cl. 188/250 B

(57) ABSTRACT

A brake shoe formed of friction material for use without a metal backing plate. The brake shoe is defined by a friction surface for bearing upon a wheel tread and an opposed back surface for being placed in contact with and secured to a brake head. The brake shoe has a reinforcing mesh defining a plurality of interstices positioned along the back surface of the brake shoe embedded in a molded friction material that is reinforced with a plurality of fibers. A keyway is at least partially formed of the molded fiber reinforced friction material extending away from the back surface of the brake shoe.

### BACKGROUND OF THE INVENTION

1. Field of the Invention

This invention relates to railway brake shoes that do not require the traditional back plate.

2. Description of Related Art

Rail cars are supported and guided by steel wheels. The treads at the outer circumference of the wheels ride over steel rails. Rail car brakes comprise brake shoes that are brought into frictional engagement with the wheel treads. The brake shoes are supported by brake heads which, in tarn, are movably supported by the brake rigging comprised of a system of levers and a pneumatic cylinder. Brake shoes are comprised of various materials that are selected for their frictional characteristics and for the effect on the wear life of the wheel treads. Many brake shoes are composites of materials having different characteristics. In a typical composite brake shoe, materials of differing frictional characteristics bear upon the wheel tread during braking

Standard railway brake shoes in North America are produced with metal backing plates for support of the friction material and for attachment and retention of the brake shoes to the brake heads. One type of railway brake shoe also includes a metallic insert solidly affixed by welding to the metal backing plate before the brake pad is formed, for example, by molding, onto the backing plate. See U.S. Pat. No. 6,241,058 entitled “Brake Shoe With Insert Bonded to Backing Plate.” The brake shoe friction material often comprises a blend of abrasive materials, organic and inorganic filler materials, and resins. The steel backing plates have a formed key bridge that fits into a recess in the brake head. A shoe key made of spring metal is hammered through the brake head and keyhole in the steel plate's key bridge, retaining the brake shoe to the brake head.

During operation, brake force is applied and released, flexing the brake shoe and the steel backing plate about the key bridge area, which cycle stresses the steel in that area. In addition, when a shoe key becomes loose, the brake shoe is subject to vibration while the rail car is moving. This bounces the brake shoe in the brake head. The key bridge of the steel backing plate impacts the inside of the brake head repeatedly causing the steel plate to break near the key bridge area. Once the key bridge is broken, some or all of the brake shoe may fall away from the brake head.

Elsewhere in the world, brake shoes are produced without metal backing plates and normally include a skeletal wire frame. A brake shoe currently manufactured in Russia does not have a conventional backing plate. The back of the shoe is supported by an encapsulated wire frame, around back edges of the shoe, crossing the center of the shoe at the top of the key bridge. See RU 2 286 275 C1. The wire frame requires special equipment to be bent into form and welded together.

It is an object of this invention to provide a plateless railway brake shoe that does not require a wire frame such as described above.

### SUMMARY OF THE INVENTION

Briefly, according to one embodiment of this invention, there is provided a brake shoe formed of friction material for use without a metal backing plate. The brake shoe is defined by a friction surface for bearing upon a wheel tread and an opposed back surface for being placed in contact with and secured to a brake head. The brake shoe has a reinforcing mesh defining a plurality of interstices positioned along the back surface of the brake shoe embedded in a molded friction material. The brake shoe is reinforced with a plurality of metal or non-metal fibers, some of which may extend through the interstices in the wire mesh. The reinforcing fibers may be discrete fibers or fibers in a mesh form or a combination of discrete and mesh form fibers. There is a keyway at least partially formed of the molded fiber reinforced friction material extending away from the back surface of the brake shoe having a keyhole therein such that the portion of the keyway behind the keyhole defines a bridge. The keyway is capable of extending through an opening provided in a brake head when the brake shoe is emplaced on the brake head.

According to one embodiment, the reinforcing mesh extends along the back surface of the brake shoe and continues through the key bridge of the keyway.

According to another embodiment, the reinforcing mesh extends along the back surface of the brake shoe and there is a key bridge strap partially encapsulated in the brake shoe.

### BRIEF DESCRIPTION OF THE DRAWINGS

Further features and other objects and advantages will be come clear form the following detailed description made with reference to the drawings in which:

FIG. 1 is a broken away perspective view of a plateless brake shoe according to one embodiment of this invention; and

FIG. 2 is a broken away perspective view of another embodiment according to this invention.

### DESCRIPTION OF THE PREFERRED EMBODIMENTS

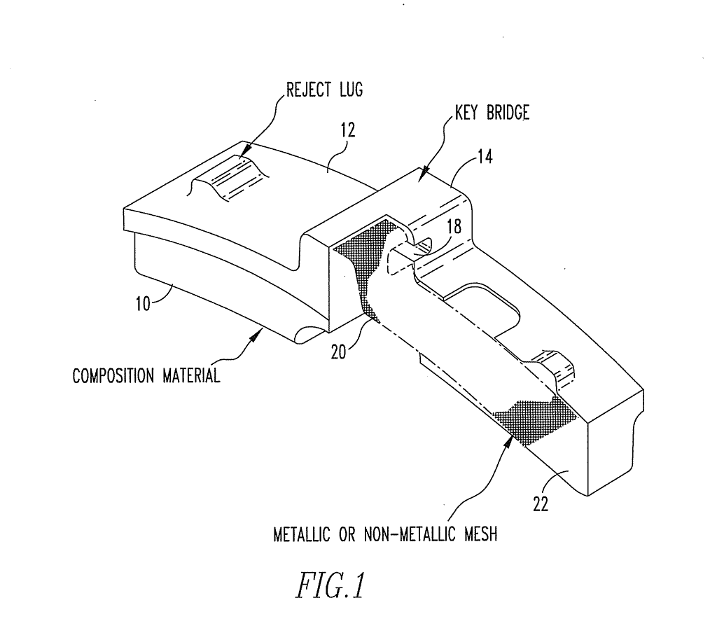

Referring now to FIG. 1, a brake shoe has a friction surface 10 and an opposed back surface 12. A key bridge 14 is positioned on the back side of brake shoe. A keyhole 18 is formed in the key bridge. A reinforcing mesh 20 is positioned along the back surface of the brake shoe embedded therein. The brake shoe is formed of a molded composite containing a plurality of reinforcing fibers 22. The compound and the reinforcing fibers extend within the interstices of the reinforcing mesh.

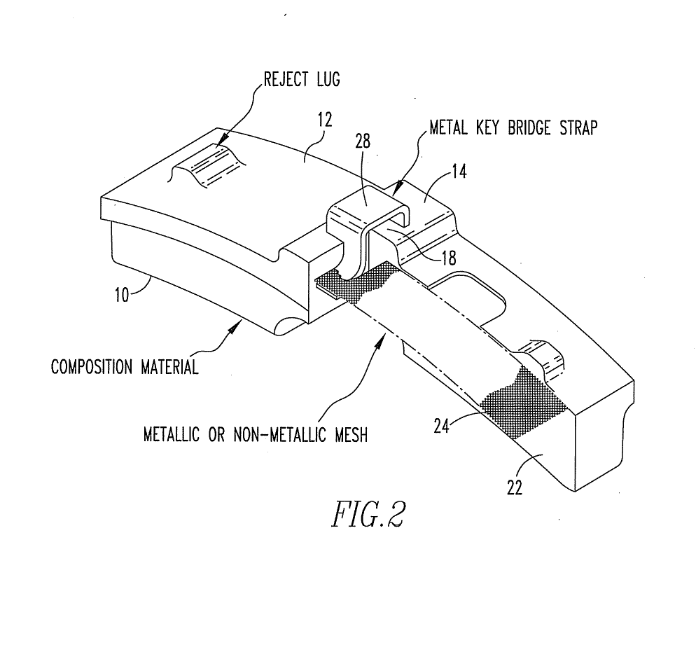

Referring now to FIG. 2, a brake shoe has a friction surface 10 and an opposed back surface 12. A key bridge 14 is positioned on the back side of brake shoe. A reinforcing mesh 24 is positioned along the back surface of the brake shoe embedded therein. The brake shoe is formed of a molded composite 22 containing a plurality of reinforcing fibers. The compound 22 and the reinforcing fibers extend within the interstices of the reinforcing mesh. A metal key bridge strap 28 is partially encapsulated in the composite material of the brake shoe. The strap 28 defines the keyhole 18.

The reinforcing mesh and the reinforcing fibers may be metallic or non-metallic.

Having thus described our invention in the detail and particularity required by the Patent Laws, what is desired protected by Letters Patent is set forth in the following claims.

The invention claimed is:

1. A brake shoe formed of friction material for use without a metal backing plate, said brake shoe defined by a friction surface for bearing upon a wheel tread and an opposed back surface for being placed in contact with and secured to a brake head, said brake shoe having a reinforcing mesh defining a plurality of interstices positioned along the back surface of the brake shoe embedded in a molded friction material that is reinforced with a plurality of fibers, there being a keyway at least partially formed of the molded fiber reinforced friction material extending away from the back surface of the brake shoe, the keyway being capable of extending through an opening provided in a brake head when the brake shoe is emplaced on the brake head.

2. The brake shoe according to claim 1, wherein the keyway has a keyhole therein, the portion of the keyway behind the keyhole defining a key bridge, and wherein the reinforcing mesh extends along the back surface of the brake shoe and continues through the key bridge.

3. The brake shoe according to claim 1, wherein the reinforcing mesh extends along the back surface of the brake shoe and there being a key bridge strap partially encapsulated in the brake shoe defining a keyhole.

4. The brake shoe according to claims 1, 2 or 3, wherein the reinforcing mesh is metallic.

5. The brake shoe according to claims 1, 2 or 3 wherein the reinforcing mesh is non-metallic.

6. The brake shoe according to claims 1, 2, or 3, wherein the molded friction material is reinforced with a plurality of discrete fibers, some of which extend through the interstices in the wire mesh.
